(19) United States
(12) Patent Application Publication
(10) Pub. No.: US 2014/0324714 A1
(43) Pub. Date: Oct. 30, 2014

(54) TOWING MANAGEMENT

(71) Applicant: OMADI, LLC, Provo, UT (US)

(72) Inventors: David Joseph Kimball, Philadelphia, PA (US); Christopher Jay Oakeson, Lehi, UT (US)

(73) Assignee: OMADI, LLC, Provo, UT (US)

(21) Appl. No.: 14/263,865

(22) Filed: Apr. 28, 2014

Related U.S. Application Data
(60) Provisional application No. 61/817,040, filed on Apr. 29, 2013.

(51) Int. Cl. G06Q 50/16; G06Q 10/00

(52) U.S. Cl. CPC G06Q 50/163; G06Q 10/00
USPC 705/314

(57) ABSTRACT

Providing information for a property. The information includes property management information related to tasks to be performed on the property. The method includes electronically identifying a location of a service provider. Based on the location of the service provider, a property associated with the location of the service provider is identified to identity a property at or near the service provider. The method further includes electronically transmitting, in real time, to the service provider information about property management for the identified property.

### CROSS-REFERENCE TO RELATED APPLICATIONS

This application claims the benefit of U.S. Provisional Patent Application No. 61/817,040 filed on Apr. 29, 2013, entitled “TOWING MANAGEMENT”, which is incorporated herein by reference.

### BACKGROUND

### Background and Relevant Art

Computers and computing systems have affected nearly every aspect of modern living. Computers are generally involved in work, recreation, healthcare, transportation, entertainment, household management, etc.

The automobile towing and property management industry is one area where computing systems may be used. Advancements in using computing in the towing industry and property management would be useful.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for providing information for a property. The information includes property management information related to tasks to be performed on the property. The method includes electronically identifying a location of a service provider. Based on the location of the service provider, a property associated with the location of the service provider is identified to identity a property at or near the service provider. The method further includes electronically transmitting, in real time, to the service provider information about property management for the identified property.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a property location and towing service provider;

FIG. 2 illustrates a flow chart showing a process flow for real time and location based violation updates;

FIG. 3 illustrates a flow chart showing a process flow for real time and location based restriction lists;

FIG. 4 illustrates a flow chart showing a process flow for restriction validation;

FIG. 5 illustrates a flow chart showing a process flow for a tag to tow conversion system;

FIG. 6 illustrates a flow chart showing a process flow for an anti-stealing system;

FIG. 7 illustrates a flow chart showing a process flow for calculating loaded mileage;

FIG. 8 illustrates a flow chart showing a process flow for calculating unloaded mileage;

FIG. 9 illustrates a flow chart showing a process flow for image uploads;

FIG. 10 illustrates a flow chart showing a process flow for digitized DOT inspections;

FIG. 11 illustrates a flow chart showing a process flow for state system automation;

FIG. 12 illustrates a flow chart showing a process flow for time based alerts;

FIG. 13 illustrates a method of providing information to a service provider regarding tasks to be performed by the service provider.

### DETAILED DESCRIPTION

In the following description, when specific technologies, parts manufacturers, transmission methods, storage methods, user input method, measures, etc. are referred to, it should be appreciated that other similar items may be substituted within the scope of the invention, and that the enumeration of items is merely for example.

Some embodiments herein are directed to facilitating a service provider providing services on a property or in a location. While the examples illustrated herein are directed to such services in the context of vehicle towing and impound, it should be appreciated that other embodiments may be practiced in other contexts.

In the context of towing, property managers may contract with towing companies to enforce various parking rules on the property. A given towing company may service a number of different locations for different customers. Each customer may have different towing policies or different rules for their location, and even different rules for different locations run by the same customer. The rules may change throughout the day, week, or year. Thus, there may be large amounts of policy and rules that a towing provider needs to keep track of.

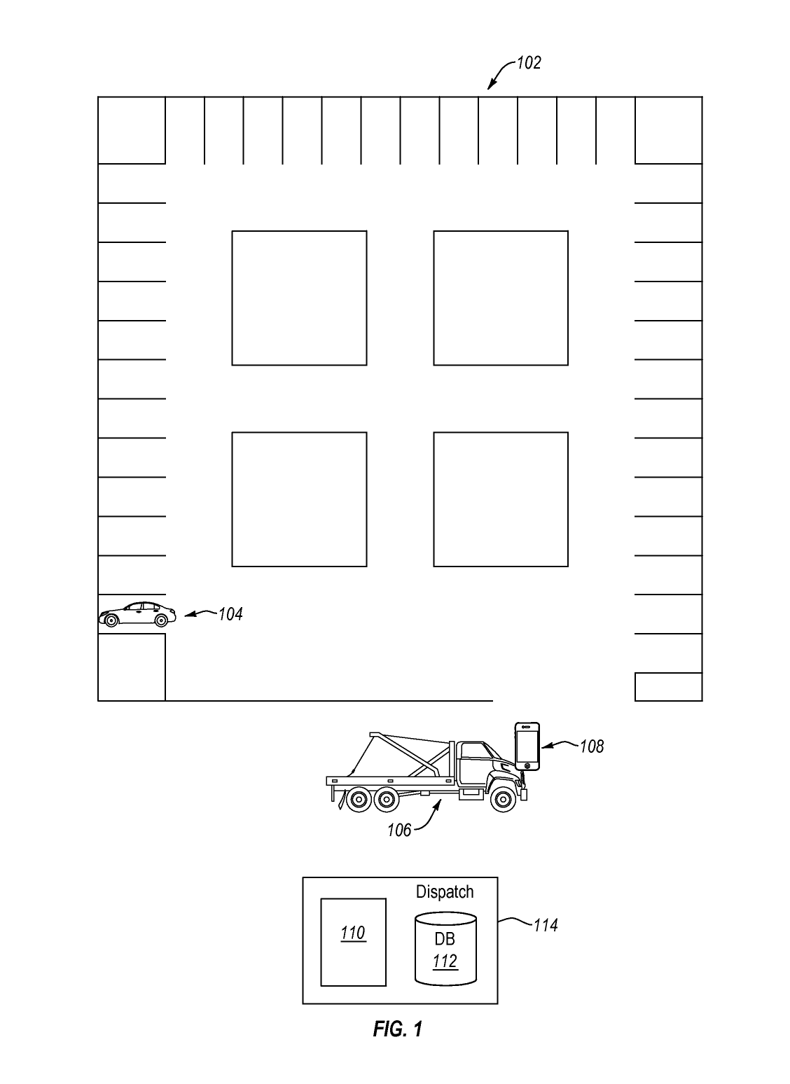

Reference will be made to FIGS. 1-12 as various embodiments of the invention are illustrated. FIG. 1 illustrates a location 102, where a towing service has been contracted to enforce rules.

Vehicle violation rules are typically specific to a location 102. Each violation can be configured, by a property manager or by a tow company, to be enforced during any combination of days and/or times during a week. Also, each violation is specific to how it is to be enforced. For example, if a vehicle 104 is parked improperly, the patrolman can tow, boot, tag, drop, or ticket the vehicle. He is unable to enter a boot, for example, on a violation that should only be towed.

As a tow driver, spotter, security patrolman, ticket writer etc. (represented by the tow truck 106) enters private property location 102 with the intention of spotting parking violators and issuing a ticket or a boot, or towing the vehicle, the patrolman presses a button (see 202) (which may be a physical button or a graphical user interface button, etc.) on their handheld device 108. The device 108 may be, for example, a PDA, smart phone device, portable computer, etc. When the button is pressed, the current location of the device 108 is retrieved via GPS satellites (see 204 and 206), cell tower triangulation (see 208 and 210), Wi-Fi location service (or via other appropriate means), or based on a last known location (see 212). That coordinate and the time (see 214) the coordinate was retrieved is then sent, for example, via the HTTP protocol with SSL encryption to a system web server 110 (see 216) using the REST methodology and JSON encoding for parameters (or using any other appropriate transmission technique). The web server 110 determines if the coordinate is located within any geofence boundary attached to violation rules in the system (see 218). Geofence data is stored and indexed, in the illustrated example, within a MySQL database 112 and using Spacial Extensions in a table with an MYISAM engine (although other appropriate databases and systems may be used).

If the patrolman's device 108 is determined to be within a geofence that is attached to specific violation rules, the corresponding violation rules are transmitted back to the mobile device 108 and displayed to the user on the mobile device 108 (see 220, 222, 224, 226, 228, 230, 232 and 234). If the location coordinate is within multiple geofences, all results will be returned. The returned violation rules may be time sensitive, as many violations are enforced only during certain days of week or times of day. The currently enforceable violations are displayed in one group, while another violation group is displayed that contains other violations that are not currently enforceable, but that may be enforceable at other times of the week or day for the specific location. See diagram for a visual representation of the data flow.

This rules system gives the patrolmen an easy-to-access listing of the property manager's wishes for violation enforcement without having to remember or lookup each violation rule for each property. New rules can be instantly made available. It gives the most pertinent information directly to the drivers so mistakes are not made.

The rules are up to date as the web server's master database 112 is queried each time the button is pressed. Mobile device date or time offsets or out of sync mobile databases do not interfere with accurate results in the violation lists being populated.

In addition to the real-time listing per account, violation checks are done on the fly as the driver is selecting a violation for a tow, boot, tag, drop, or any other form type that uses violation fields. In some embodiments, only the currently enforceable violations are available for selection in the violation list. Some embodiments may make it impossible for a driver to select a non-enforceable violation in the forms if the enforcement date/time and property information is correct.

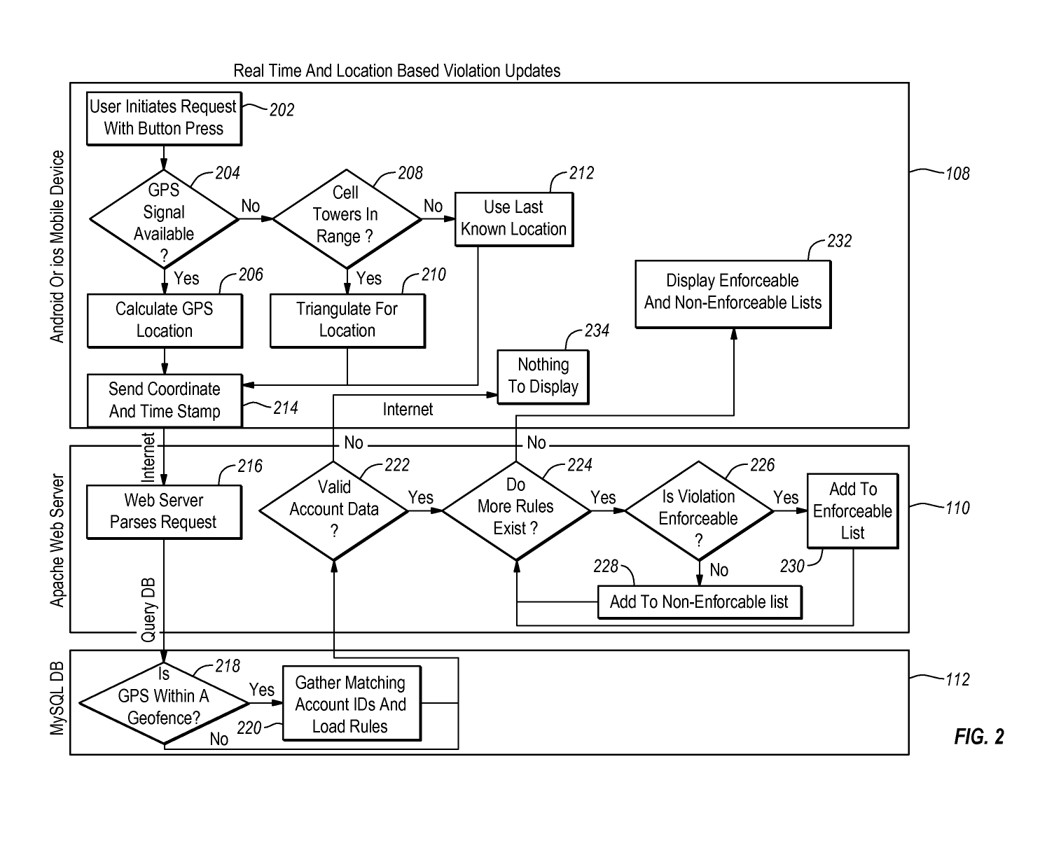

See the flow chart “Real-Time and Location-Based Violation Updates” illustrated in FIG. 2 for an illustration of one example process flow.

### Real-Time and Location-Based Restrictions List (Do not Tow or Immobilize List)

As a tow driver, spotter, security patrolman, ticket writer etc. enters private property with the intention of spotting parking violators and issuing a ticket or a boot, or towing the vehicle 104, the patrolman presses a button on their handheld device 108 (see 302). When the button is pressed, the current location of the device 108 is retrieved via GPS satellites (see 304 and 306), cell tower triangulation (see 308 and 310), Wi-Fi location services, and/or other appropriate location service, or based on a last known location (see 312). That coordinate and the time the coordinate was retrieved are then sent via the HTTP protocol with SSL encryption to a system web server 110 using the REST methodology and JSON encoding for parameters (see 316). The web server 110 determines if the location coordinate is located within any geofence boundary attached to a vehicle or property restriction in the system (see 318). Geofence data is stored and indexed within a MySQL database 112 (or other appropriate database) and using Spatial Extensions in a table with an MYISAM engine.

If the patrolman's device 108 is determined to be within a geofence that is attached to a vehicle or account and/or location (e.g. a property) restriction, the restriction rules are transmitted back to the mobile device 108 and displayed to the user (see 320, 322, 326, 328, 332, and 334). If the location coordinate is within multiple geofences, all results will be returned. The returned restriction rules are time sensitive, as they may start or end at arbitrary dates and/or times.

Restrictions are entered via a user interface, such as a user interface implemented in a web browser at a system subdomain and stored in a database 112. Restrictions can alternatively or additionally be entered via the mobile apps such as on Android and iOS (or any other appropriate platform for which an app has been developed). A parking enforcement company employee has the ability to enter restrictions for any account and/or location (e.g. a property). A property manager has the ability to enter a restriction for his/her own account and/or location (e.g. a property). A restriction can restrict all parking enforcement for an entire property for a given time, or it can restrict a specific vehicle 104, which is identified by either the license plate or the VIN at a given time. It also collects other vehicle identifiers like make, model and color that help the patrolling driver see which vehicles are restricted more easily without having to match license plate numbers or VINs.

Restrictions may be kept up to date as the web server's master database 112 is queried each time an appropriate button is pressed. Mobile device date or time offsets or out of sync mobile databases do not interfere with accurate results in the restriction lists being populated.

After a restriction has “expired” it is automatically removed from the restriction list the next time the alert button is pressed for that account.

This restriction system gives the patrolmen an easy-to-access listing of the property manager's wishes without having to remember each request for all patrolled accounts and/or locations (properties). Mistakes are not made as frequently when having a real-time list of updated restrictions available at the touch of a button. Property managers are happy as they do not need to contact their parking enforcement company to add a restriction as a username and password for login is provided to property managers in order to update restriction lists, request tows, update violation rules, etc.

Additionally, if a patrolman goes to tow a vehicle 104 that is on the restriction list, he will be prompted that the vehicle 104 cannot be towed or immobilized. Vehicles can also be restricted for all violations in general, or for specific violation rules (i.e. expired registration).

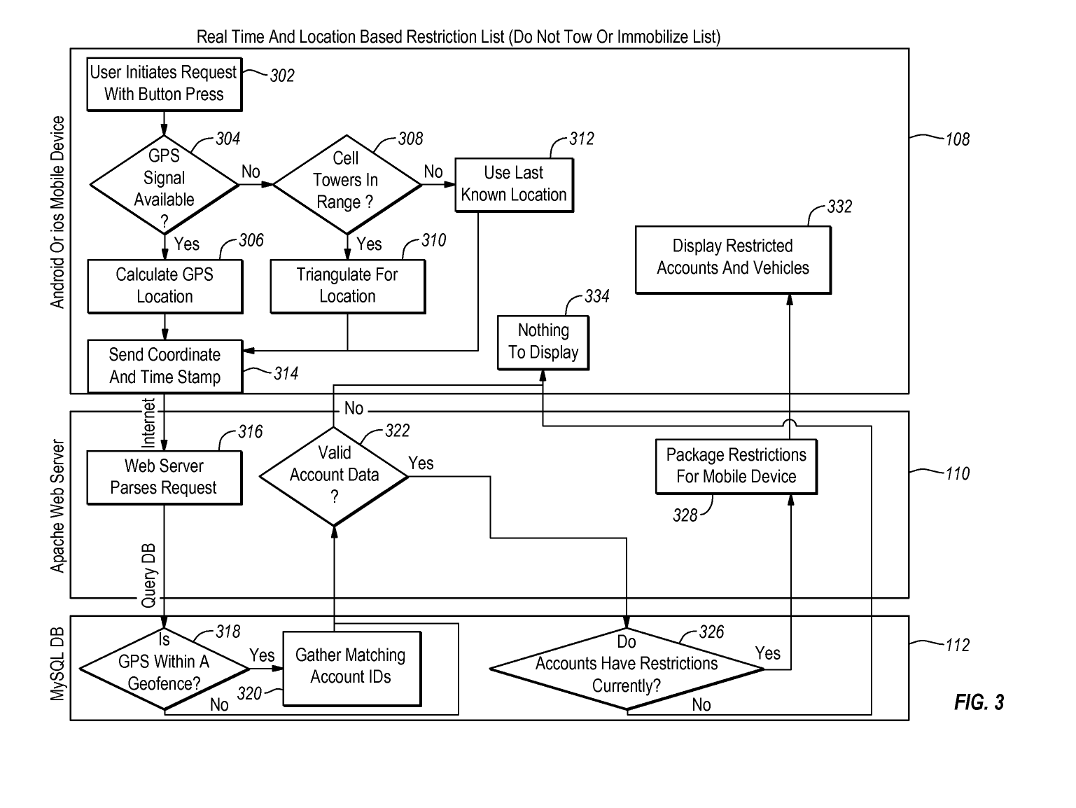

See the flow chart “real-time & location-based restriction list (do not tow or immobilize list)” illustrated in FIG. 3 for one example process flow.

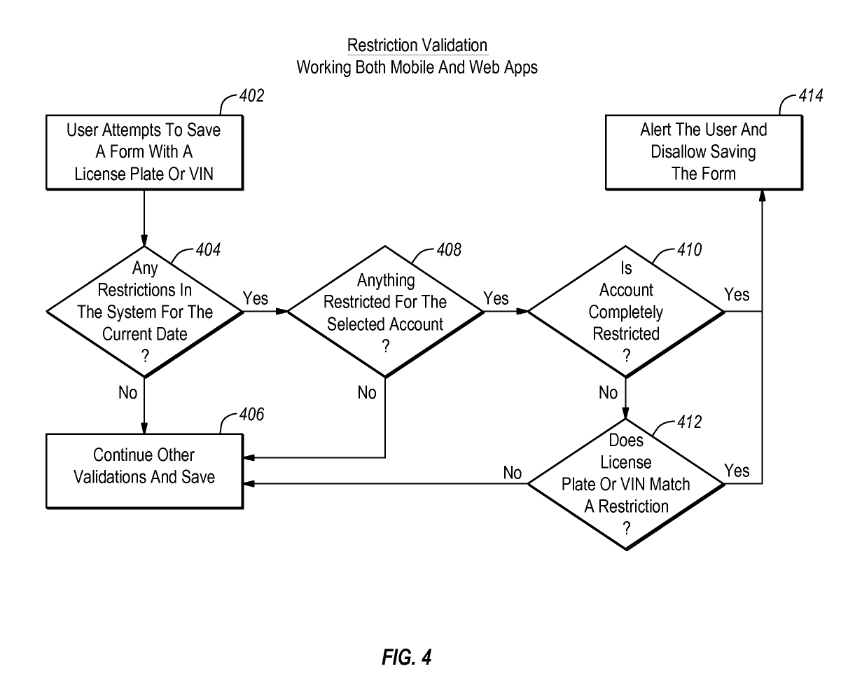

See also the flow diagram “restriction validation” in FIG. 4 illustrating a flow of how a validation process may be accomplished for determining whether or not forms can be updated based on restrictions. In FIG. 4, a user attempts to save a form with a license or vin on mobile app (see 402). The system attempts to determine if there are any restrictions in the system for the current date (see 404). If not, then the system continues other validations and saves the updates to the form (see 406). If so, however, the system attempts to determine if there is anything restricted for the selected account (see 408). If so, the system attempts to see if the account is completely restricted (see 410). If not, the system attempts to determine if the license plate or vin match a restriction (see 410). If so, the user is alerted and the form is not allowed to be saved. See 414.

### Tag to Tow Conversion System

Many parking enforcement companies post a “tag,” “sticker,” or “warning” on a vehicle 104 to give a specific amount of time (usually between 24 and 96 hours) to become compliant in the parking rules for an account and/or location (e.g. a property). Some states or municipalities require tagging before other actions can be taken, and some property managers request this service. Managing the tags and their expirations and/or property manager approvals becomes very tedious to any tagging or parking enforcement company.

A tagging system gives drivers, property managers, and parking enforcement companies complete transparency and knowledge into which tags are still in the field and the status of each.

An employee of a parking enforcement company can create a tag (see 502) for any account and/or location (e.g. a property). General vehicle information is stored in the system including license plate, make, model, color, time of tag, tagger, photos, how many hours until the tag expires, etc. All the information is stored on a system web server.

Because of different management styles of each property manager at each account and/or location (e.g. a property), embodiments have at least two options for each account: (1) the tagged vehicle 104 can be towed or immobilized immediately after the tag's time limit has expired without manager approval, or (2) the tagged vehicle 104 can be towed or immobilized only after the tag has expired and the manager has given approval (see 506, 510, 516, 518, 520, 522, 524, 526, 528, 530). When the manager wants to give approval for each tag (see 510), a tag approval web page is created for them when they login to the system. On the tag approval web page, the property manager can check one of two or three checkboxes for each tagged vehicle 104 (Tow when expired, Do not Tow Until After, and In Compliance).

The ‘In Compliance’ checkboxes can be disabled if the administrator does not want property managers to determine when the vehicle 104 is in compliance.

If the manager checks ‘Tow when expired’, the tag will be available to tow or immobilize immediately if the tag has already passed the expiry time (usually between 24 and 96 hours). Otherwise, the tow or immobilization will be allowed once the expiry time has passed. The manager can come back to the tag approval page anytime before the vehicle 104 is towed and change the selection if desired (see 512).

If the manager checks ‘Do not tow until after’, a date field will pop up. The manager can then give an allotted time to allow the vehicle 104 owner to be in compliance (see 512). Once the selected date/time has passed, the system will expire the tag and allow the vehicle 104 to be towed or immobilized (see 528) if the vehicle 104 is still in violation of the violation rules.

If the ‘In compliance’ box is available and the manager checks that box (see 504), it is just as if a patrolman went to the property and found the vehicle 104 to be in compliance. That vehicle 104 will not be allowed for towing or immobilization until it is found that the vehicle 104 is in violation with a brand new tag.

When a tag has both expired and been approved by the property manager, then those tagged vehicles will show up in the mobile app in two ways:

(1) As a tow driver, spotter, security patrolman, ticket writer etc. enters private property with the intention of spotting parking violators and issuing a ticket, tag, boot, or towing the vehicle 104, the patrolman presses a button on their handheld device 108. When the button is pressed, the current location of the device 108 is retrieved via GPS satellites, cell tower triangulation, Wi-Fi location service and/or other appropriate means. That coordinate and the time the coordinate was retrieved is then sent via the HTTP protocol with SSL encryption to a system web server 110 using the REST methodology and JSON encoding for parameters. The web server 110 determines if the location coordinate is located within any geofence boundary attached to a tag form entry in the system. Geofence data is stored and indexed within a MySQL database 112 and using Spatial Extensions in a table with an MYISAM engine.

If the device 108 is determined to be within a geofence that is attached to a tag that has expired and/or is approved for the account and/or location (e.g. a property), the available tags are transmitted back to the mobile device 108 and displayed to the user. If the location coordinate is within multiple geofences, all expired tag results will be returned. The returned tags to tow or immobilize are time sensitive, as they may expire at any time or may be approved at any time.

(2) When a company does tagging, an “Expired” button appears on the mobile app. When that button is pressed, all available expired tags that the current user has available for towing or immobilization will be listed across all accounts. This allows tags to be converted into tows or immobilization more frequently as the property does not need to be visited to see which tags have expired.

The majority of use cases allow any driver to tow or immobilize any expired tag. However, some parking enforcement companies want to give the towing or immobilization permission to only the driver who created the tag. In that case, a setting in the system allows for that additional permission so that a driver will only see expired tags for the vehicles he/she tagged in the first place. These permissions can also be setup to be violation-specific. As an example with this additional permissions setting, anybody can tow a tagged vehicle 104 that was backed into a stall, but only the initial tagger can tow the vehicle 104 for an expired registration.

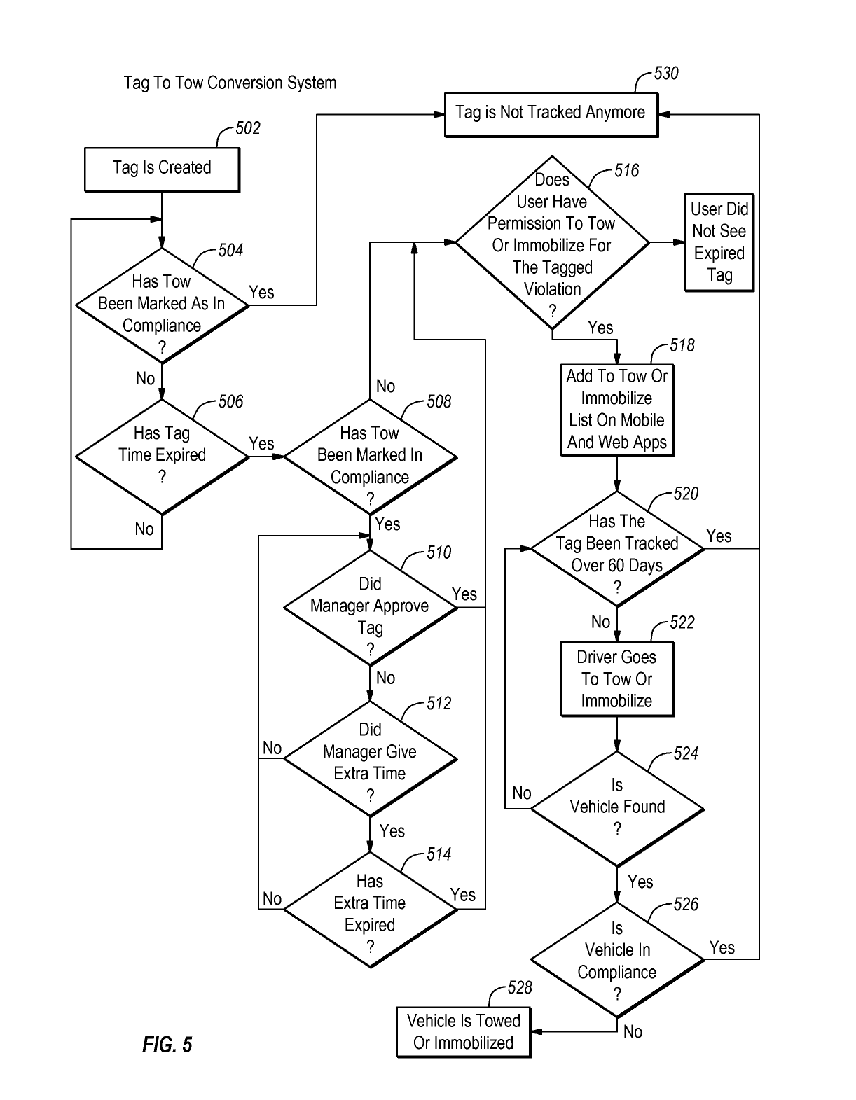

See the flowchart titled “Tag to Tow Conversion System” illustrated in FIG. 5 for one process flow that may be implemented.

### Anti-Stealing System

Embodiments may be implemented where Xirgo XT-2150 GPS units (from Xirgo Technologies of Camarillo, Calif.) (or other appropriate GPS or geo-location units) are installed into vehicles, which have at least two digital inputs. Embodiments use one input to track the ignition being on or off, and embodiments use the other to track the status of the power take-off (PTO) that exists on many tow trucks. The PTO is used to power the tow truck's boom, wheel-lift or flatbed. A tow can typically only be completed when engaging the PTO.

The GPS units are continually sending data to system servers via a UDP connection on the T-Mobile GPRS (or other carrier) network. When the ignition is turned on or off, or when the PTO is engaged or disengaged, a message is sent to the system servers with information that includes position, PTO status, ignition, speed, direction, time, and other information. That information is taken by the web server 110 and stored in a MySQL database 112 for analyzing in the future and for instant reports (see 602 and 604).

Since UDP connections are not always reliable, and if the PTO alert does not make it to the system web servers, then any successive messages from the GPS unit are parsed. Ignition and PTO information is then gathered from those requests and stored in the database 112. Those successive messages are typically sent in intervals of at least 30-60 seconds apart. They are also typically sent when the driver turns more than 40 degrees, when the tow truck vehicle 106 stops for at least 2 minutes, or begins to move. So, if a PTO message is missed because of poor GPRS reception, the PTO being engaged or disengaged will be picked up on the next message that the web server 110 receives.

If a driver engages his PTO an irregular amount of times or in irregular places without inputting information into the system signifying that he is conducting tows, then the business owner or manager can be notified via email and/or SMS text (or by other appropriate means) (see 622). This solves one of the most problematic ways that drivers steal from towing companies by conducting tows on the side. See 606, 608, 610, and 612 for examples of how various calculations may be performed.

The system may give the driver a specific amount of time (in some embodiments, this defaults to 30 minutes) to enter the towing information into the system after a PTO is engaged or disengaged (see 614 and 616). If after that time has elapsed and the driver has not entered the towing information, the alert is sent out to the driver's manager (see 618, 620 and 622).

Some tow trucks 106 have the PTO engaged at all times while the vehicle 106 is in tow while others only engage the PTO while the vehicle 106 is loading or unloading. Therefore, the PTO type is configured for each vehicle to determine if one or two PTO engage/disengage phases happen per tow so alerts are sent out correctly.

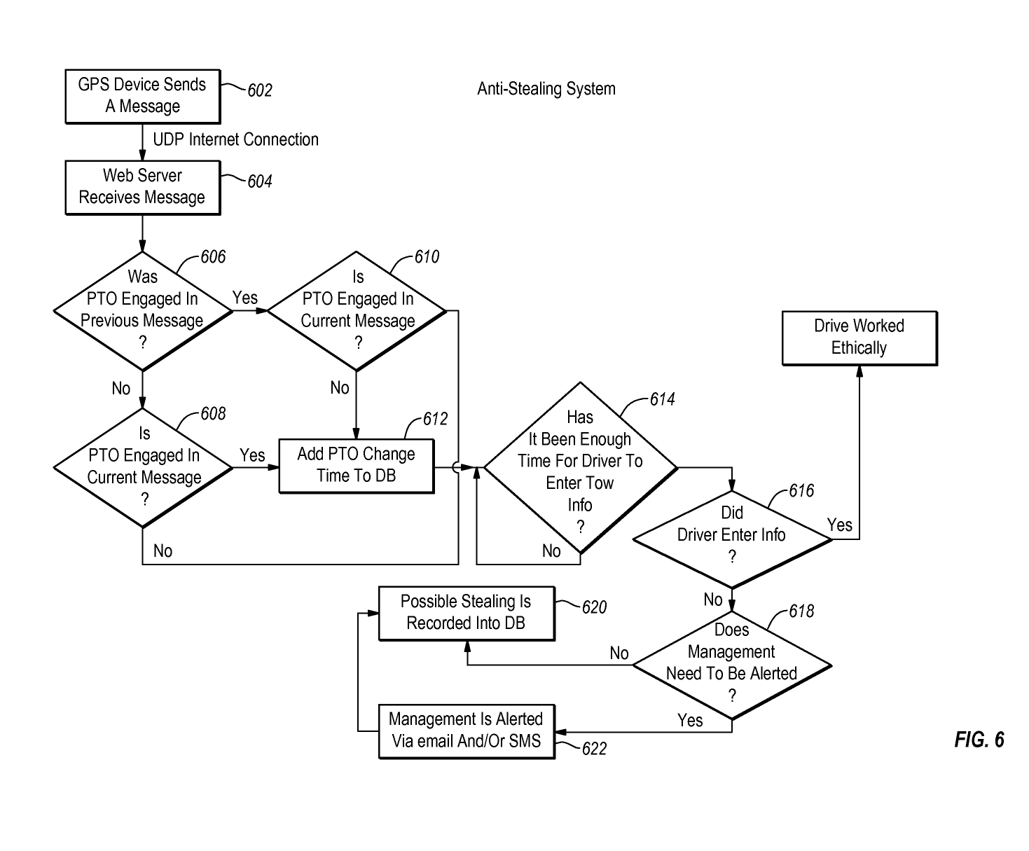

See the flow chart “Anti-Stealing System” illustrated in FIG. 6 for one example workflow.

### Dispatch to any Form, Statuses and Minimum and Actual Mileage

The system's dispatch system 114 is engineered to allow one entry point to dispatch any type of action that a customer wants. A new dispatch is created by a dispatcher: entering the information manually, on the web or mobile app, or by information coming in through fax, email, or through a web service or socket IP connection provided by a motor club or other entity, or in other appropriate ways. Once the address of the dispatch location and the type of action is entered, the dispatcher clicks the save button and customized information is presented to the dispatcher for the specific action they are dispatching. The administrator or customer sets up which information is required for the dispatcher or driver to enter into the system. A map is also presented to the dispatcher with locations of vehicles in proximity to the dispatch location. The dispatcher can then select which vehicles or users of the system to send a dispatch request to by clicking on the map icons or in a multi-select list.

The requested users are sent a dispatch message using a push notification system, such as that hosted by Appcelerator Inc. of Mountain View, Calif. (or other service). These push notifications are sent to Android and iOS (or other platform) devices which then load the new job from the dispatcher. Out of the dispatched users, in some embodiments, the first to click on the new job and accept it will get the job, and it goes into their open jobs list. Although it should be appreciated that other prioritization schemes may additionally or alternatively be implemented.

The driver can get turn by turn directions to the job with the click of a button.

The driver can update the status of the job, which in turn timestamps that status for entry into motor club, state, or other entity's systems (see e.g. 702, 704, 802, and 804). Statuses, in some embodiments, are as follows: Call Received, Dispatching Call, Job Accepted, Driving to Job, Arrived at Job, Towing Vehicle, Arrived at Destination, Job Complete.

When the driver updates the status to job complete, the job will move out of the open jobs list for that user as well as the full dispatch list viewed by the dispatcher.

Unloaded and loaded mileage can be computed using the distance travelled by the truck coupled with the GPS units. Unloaded mileage is calculated by taking the Driving Job status update time and the Arrived at Job status update time and getting the distance information transmitted from the GPS device between those two times. Loaded mileage is calculated by taking the Towing Vehicle status update time and the Arrived at Destination status update time and getting the distance information transmitted from the GPS device between those two times (see 714 and 814).

If the driver does not update the status manually (see 716 and 816), the system will automatically update (see 706 and 806) the status to Arrived at Job when the driver enters within a predetermined proximity, such as about 500 meters (or some other appropriate distance) of the dispatch location. Likewise, if the driver enters within a predetermined proximity, such as for example, about 500 meters (or some other pre-determined distance) of the tow destination, the system will automatically update the status of the job to Arrived at Destination (see 708, 710, 712, 808, 810, and 812). With automatic updating enabled (see 706 and 806), the actual loaded and unloaded mileage will be accurate to within 1 kilometer, in the illustrated example. If automatic status updates are not enabled, accuracy will be as accurate as the accuracy of the GPS devices, which is usually less than 10 meters, depending on reception and interference.

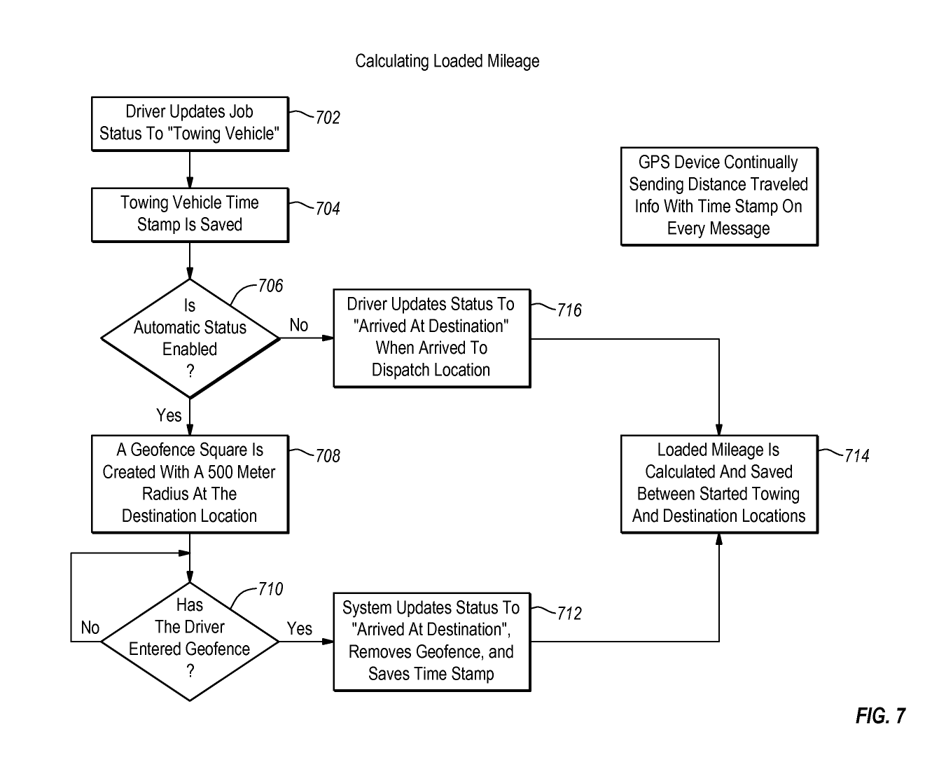

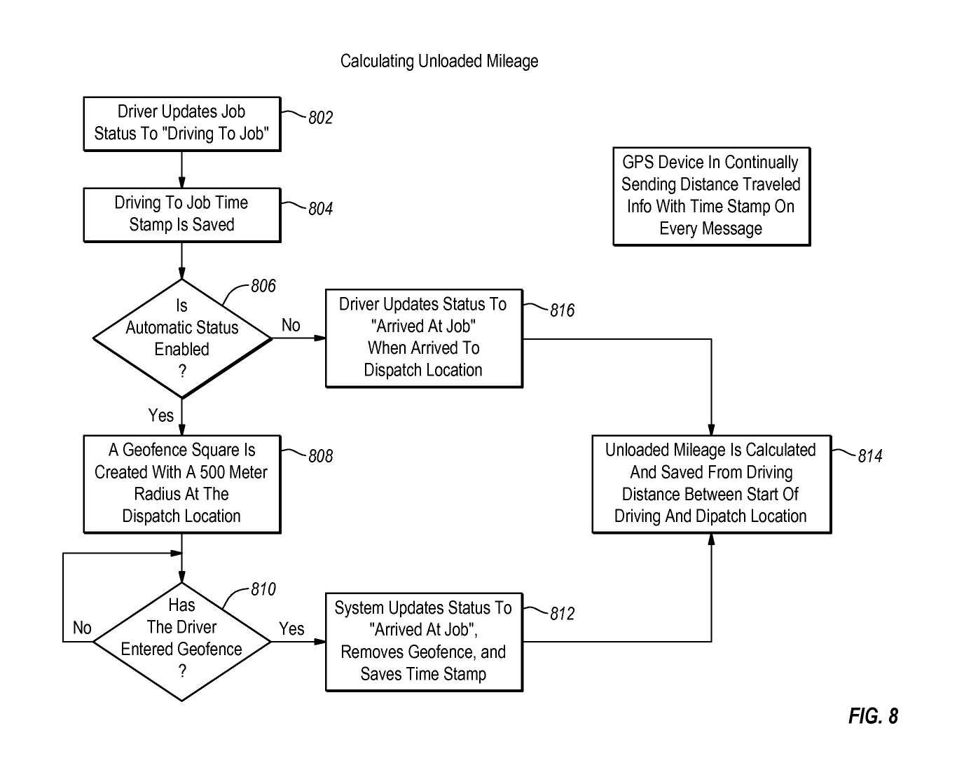

See FIG. 7 titled “Calculating loaded mileage” and FIG. 8 titled “Calculating unloaded mileage” for example flows that may be implemented in some embodiments.

### Parent Form Tokens

Embodiments may implement a format of replacement tokens that is unique in that it can replace values from one form, but also values from a parent form, linked by a form reference.

These tokens are used in creating customized email templates, document templates in MS Word, PDF exported documents, SMS text messages, etc.

Simple human-readable tokens are used to indicate what should be included. When the generated document, email, or text is sent out, the tokens are replaced by the actual values stored in the database 112.

An example token for the vehicle model for a tow is like this: [tow:Vehicle:Model]

Street address of the account where the vehicle was towed: [account:Property_Address:Street]

First name of the person embodiments are sending the email to: [user:FirstName]

The current date: [metadata:current_date]

The tow yard the vehicle was towed to: [tow:Tow_Yard]

Embodiments may use this format of tokens because they use the field label instead of the database field name, which is not as readable and can differ from the field label as labels change throughout time. The most popular token replacement scheme looks like this: $ {tow_yard}. Additionally, embodiments are able to reach into parent forms to get linked information, which is not done in conventional token replacement schemes.

The purpose of the first part of the token like ‘tow’ or ‘account’ in the above examples specifies where the information should be coming from, whether it be from the tow form or from the account form linked from the tow form, or any other registered parent form the tow may have.

Since field labels change, token replacements are changed throughout the entire system in email and SMS text templates to reflect the new field label immediately. This global change makes it so tokens do not have to manually be changed in every tokenized document in the system.

### Calculation Field and Search Criteria

Embodiments may be configured to use a type of field that is able to do many types of calculations and cache different parts of that data for quick retrieval from the database 112. Some embodiments refer to it as the ‘calculation or static value’ field, and it is fully functional for mobile and web and can be placed on any form in virtually any quantity. The field has many options to calculate simple figures and amounts based on customizable criteria embodiments feed it through a web interface.

Each calculation field can have multiple rows of calculated or cached information. Each row is added together to provide the total amount with each row having a label to show what each row refers to. Each row can multiply two fields together, grab information from a parent form entry, bring in numbers entered in a user account, calculate time and date differences, round to minutes, hours, days, or weeks, and multiply in static values. Each row also can be used on condition of the form being in a certain state by using a general ‘search criteria’.

The ‘search criteria’ is used for many areas of the web and mobile apps to filter data based on customizable criteria embodiments feed it. It is used to filter data in reports, list views, email and SMS text message alerts, and calculation fields.

For date fields, embodiments can filter on after, before or between an exact date or relative date, after time of day, before time of day, between times of day, the weekday, filled, or empty.

For decimal, integer, auto increment, calculation fields, embodiments can filter on empty, filled, equal to, >=, >, <, <=, !=

For text, long text, license plate, list items, email, phone, Internet link fields, embodiments can filter on empty, filled, contains text, equal to, not equal to, starts with, does not start with, ends with, does not end with. For non-autocomplete item list widgets, embodiments can also filter on one or more specific items.

For checkboxes embodiments can filter on checked and unchecked.

For time-only fields, embodiments can filter on before time of day, after time of day, and between times of day.

Calculation values have the option of being hidden on forms if they are used only in background tasks such as tokens in documents or emails.

Each row has the option to be hidden if it is a zero value, and different decimal and monetary formatting can be applied based on the field's use.

An option to add in a recalculate button on the web and mobile apps is used to recalculate the value if key information has changed such as a date or time, or parent form values such as the account being serviced.

### Photo Management, Image Fields, Timestamps, and Signatures

The illustrated embodiments have different field types that have differently with different validations, formats and some field types have multiple widgets to choose from. One of those field types is an image field. Like most field types, it can be simply configured to allow only 1, 2, 3, 4, 5, or 6 (or other appropriate values) photos taken and uploaded. It can also accept unlimited photos (up to the maximum capacity of the device and servers). Any number of image fields can be placed on any form.

On the web-based version, in some embodiments, photos can only be uploaded by choosing an image from the filesystem and uploading. For example, photos may be uploaded to document or report violations, to verify what vehicle is being towed, or for other reasons. When using the mobile app, photos are taken using the device 108's camera (see 902). Those photos may be immediately resized to a smaller dimension that is big enough to see details, but small enough to not take up too much bandwidth for the user's data plan. Data sizes of some example embodiments range from between about 200 KB to just under 1 MB depending on what is in the photo, the camera taking the photo, and the operating system of the device 108. The photos are stored in the mobile device 108's filesystem (see 904), and once successfully uploaded, they are deleted from the filesystem to free up space (see 906). A mobile user also has the option to select recently snapped photos from their photo gallery if they would like to use a different camera app or would like the changed workflow of not needing to open and start filling out a form to take photos.

Each photo keeps track of its own upload failure count. Photos with the lowest failure count are sent to be uploaded before photos that have failed more times. This is to get the highest number of photos uploaded in the shortest amount of time. Reasons for a failure could be a network failure while uploading or the form entry that the photo would attach to was deleted before the upload.

Once a photo fails to upload after 5 times (or other appropriate value) when having a network connection and at least, for example, 1 hour of time has passed, the photo stops attempting to be uploaded to the web server (see 908).

A photo timestamp is sent along with each photo. Also, a location coordinate from where the photo was taken. To avoid the timestamp being bad because the user sets the time to a different time than the actual time, the mobile app looks at the UTC timestamp of the server every time it syncs. The timestamp sent to the server is then adjusted based on the UTC timestamp of the web server 110 (which is always correct). Therefore, the user cannot upload an incorrect timestamp of a photo.

Photos and any files, in some embodiments, are uploaded to the web server 110 via the HTTPS protocol and using REST methodology. The files are base64 encoded during transmission in a POST request.

Signature fields behave like an image field as described above, except a camera is not used. The devices offer a blank canvas for users to sign their name using their finger or a stylus.

Signature fields can be added to any form, form part, and in as many places as the customer wants a signature.

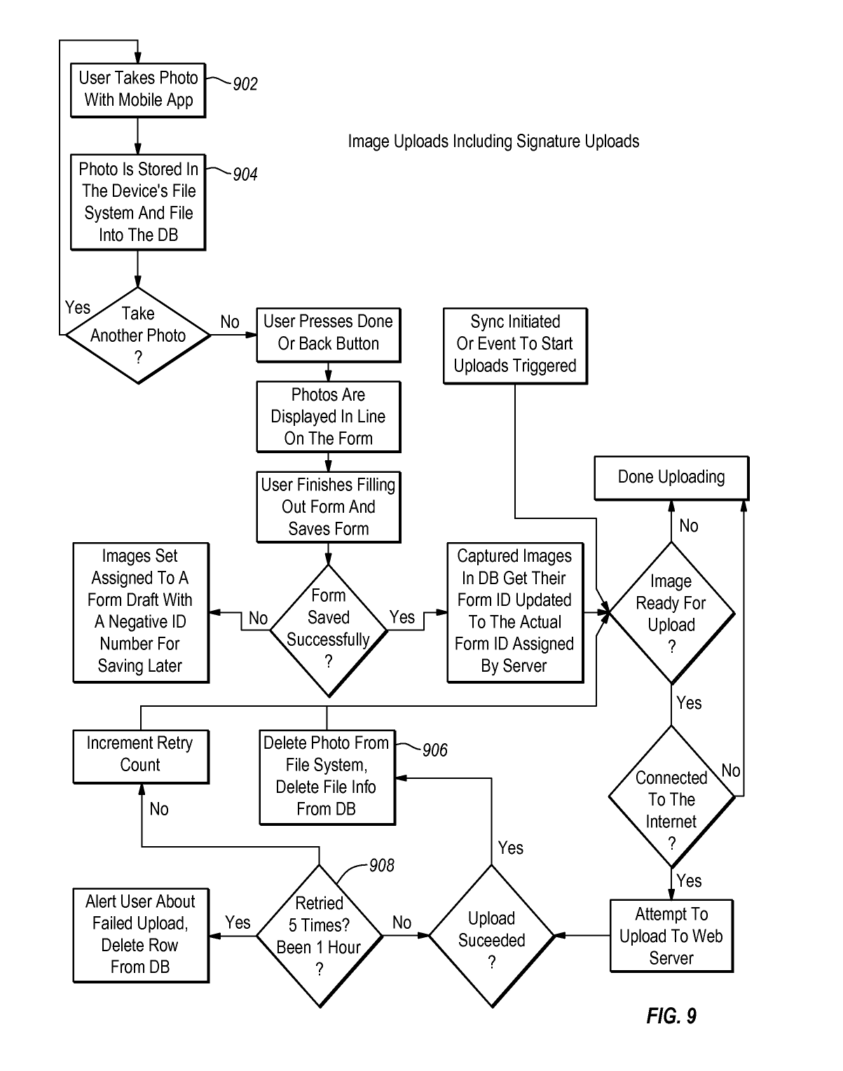

See FIG. 9 illustrating a flow chart “Image Uploads including Signature Uploads” which shows an example flow that may be implemented in some embodiments.

### Digitalized DOT Inspections

Embodiments may implement a very easy-to-use method for complying with the Department of Transportation's (DOT) mandate for a driver to review a vehicle's inspection log before driving the vehicle and filling out a new inspection report at the end of his shift.

When the driver opens up the system mobile app and logs in (see 1002), one of the first things the driver will come to is a question asking whether or not he/she wants to review the last inspection report. If the driver presses ‘Yes,’ he/she will select which vehicle they want to see the inspection report for, and then view the last inspection report (see 1004, 1006, 1008, and 1010).

The driver will then click the ‘Review or Repair’ button, review the inspection report, and sign it using a signature field (see 1012). This signifies that the driver knows about any damage, etc. before operating the vehicle.

When a user clicks the ‘logout’ button on the mobile app (see 1014), the app will pop open an alert asking if the user wants to fill out a post-shift inspection form if one wasn't already filled out within the last hour by that same user. If yes, the user will then fill out a digitalized copy of the information the DOT looks for when doing audits at a trucking or towing company (see 1016, 1018, 1020, 1022 and 1024).

If there is something wrong with the vehicle, the manager or owner of the tow company will be notified immediately by email or SMS text and will continue to receive reminders until he notifies the system that the repair has taken place.

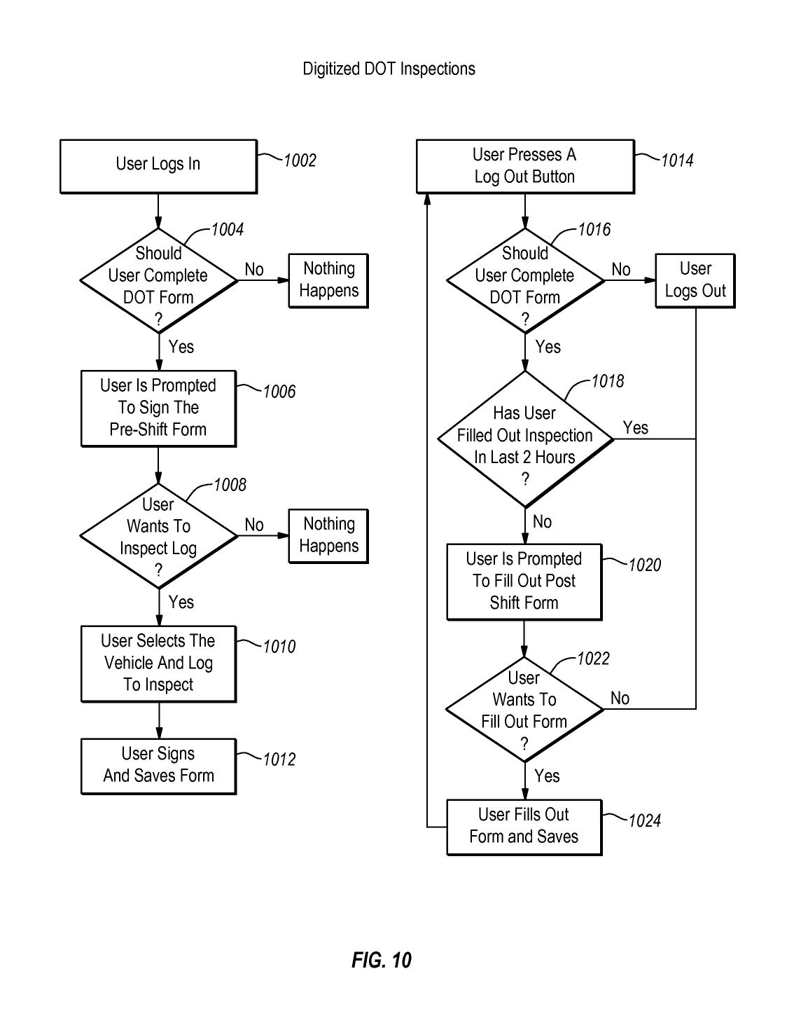

See FIG. 10 and the flow chart labeled “Digitalized DOT Inspections” for an example of a process flow that may be implemented in some embodiments of the invention.

### State or Other Entity System Automation

Many states and local entities require information to be put into their system when a private property impound has occurred. After all of the necessary information has been put into the system, the system automatically logs into the state or other entity system with encrypted credentials the tow company provides. The system then systematically enters in all of the necessary information using form POST requests, and receives a confirmation number and any other necessary information from the state. The system then stores that information into the system for future reference.

If police stations allow emails as notifications, then the system will send automatic emails to the police station with all of information the police station requires for a tow to be lawfully completed.

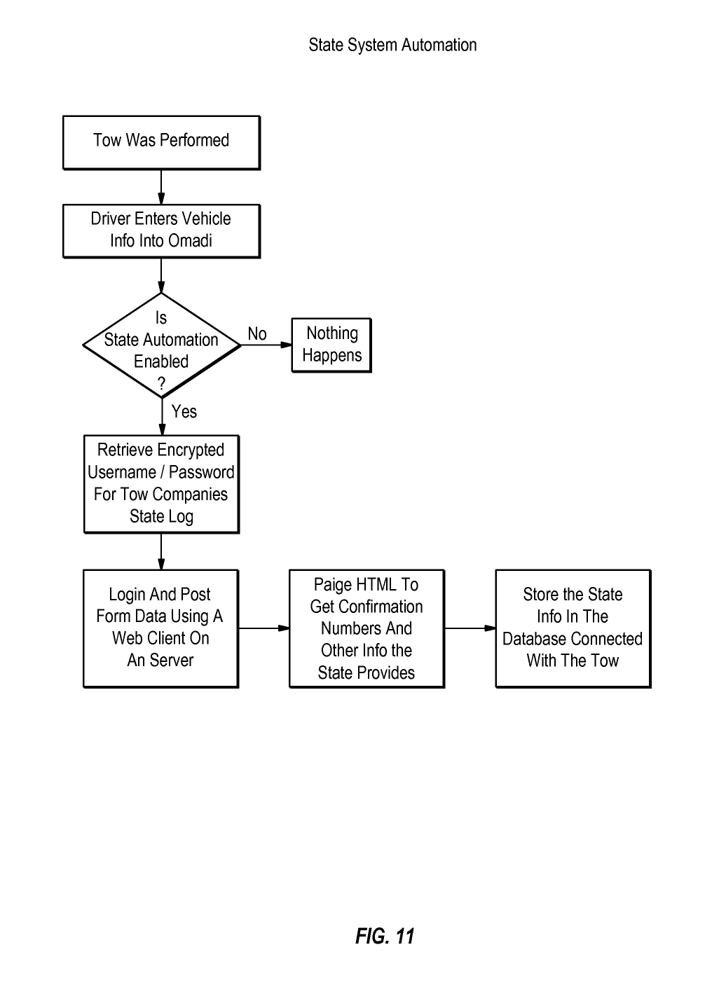

An example flowchart of this process is illustrated in FIG. 11 titled “State System Automation”.

### Automated Time-Based Alerts and Conditional Alerts

Emails and SMS text messages are sent depending on almost any set of criteria using the system's general ‘search criteria’ as explained above. Managers can also receive emails or text messages when other events in the towing process occur besides just when the vehicle is towed—like when the vehicle reaches the tow yard or when the vehicle is released to the owner or when paperwork must be sent to vehicle owners or to the state. Administrators can specify exactly when the emails/texts go out and exactly which content is in both the email and/or SMS text. Administrators at the tow company can easily turn on or off alerts to individual property managers. Alerts can be made for any form type and for almost any condition.

### Time-Based Alerts

When an alert must be sent out at a future period (based on customizable criteria) without any user interaction, a time-based alert can be setup. This acts somewhat like a reminder alert in other systems. When a form is saved (see 1202), a timestamp is saved in the database 112 (see 1204) for when the system should check the condition again. Using, for example, the Linux Cron function, the cron calls PHP functions every minute to check the database 112 (see 1206) and whether or not the condition is still met after the specified time period has lapsed. If the condition still holds, the alert is sent out (see 1208, 1210 and 1212).

Photos can automatically be sent in an email alert by inserting thumbnails in the email body and attaching the photo to the email in a multipart email message using PHP's mail methods to individual property managers (when requested).

SMS alerts are sent to specified cellular carriers using the general SMS email for each carrier. Each user that signs up for SMS alerts must verify they own the phone number they are receiving alerts on by entering a validation code that the system sends to their mobile number.

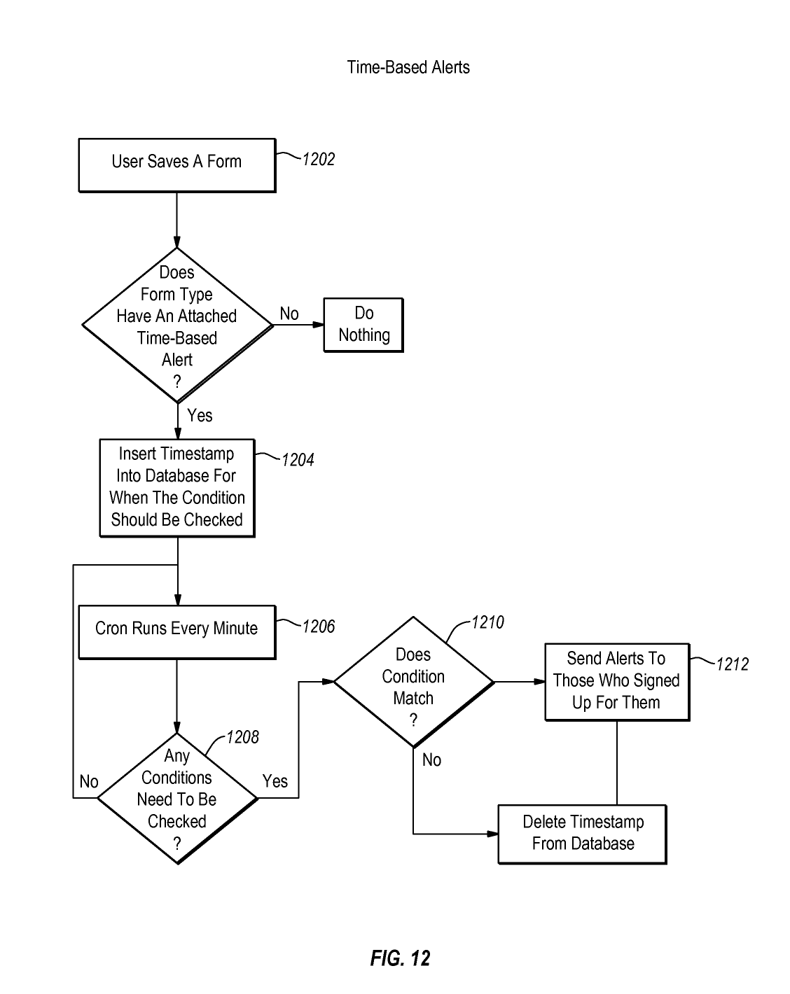

See FIG. 12 titled “Time-Based Alerts” for an example flow chart that illustrates one process flow that may be implemented in some embodiments of the invention.

### Property Management Portal

The system has several permission levels in the system, such as for example: Site Admin, Office Staff, Dispatcher, Sales, Patrol, Client.

A client is attached to an account and/or location (e.g. a property) so they can only see results that are attached to their specific account. When a client logs into an account they are able to see reports as to the kinds of tows, boots, tags, or tickets that were conducted on their property along with detailed information and photos of each event.

Whenever they access any piece of information in a list or when search for a violation by license plate, or when looking at tags to approve, the SQL query sent to the MySQL database 112 (or other appropriate query for other databases) is altered to make sure that there is an account attached to that piece of information and that it is in fact attached to the account they were assigned.

An account can have a parent account attached (i.e. for a regional or district office over several properties). When assigning a client login to a district-level account that has children accounts, in some embodiments, all children are included in the query explained above so they do not need to have a separate login for each property they manage.

### Customizable Reports

Just about any report can be generated with the customizable reports. Similar to the calculation field, a report uses basic building blocks to create a detailed listing of date-sensitive information.

Each row of a report has a unique label that identifies what information it is calculating. All rows in a report can be added together to form an aggregate total.

The report can be split into categories of users, form references, or list items. For example, a payroll report can be generated, with each user getting a report created for them. A revenue report can be created that is split up by account. A payment type report can be created that splits revenue up by payment type. There is an aggregate total section for the administrators to see.

Reports have permissions so specific roles are able to see a report, while restricting other roles. A report can be added to the dashboard. Reports can be configured allow a user to see only his/her specific information, none of the information, or all the information in the system.

Reports can have different number formats and rounding schemes like currency, or round to the nearest integer, round down, round up, round to the nearest 3 decimal places, etc.

Reports can be displayed in table format, pie chart format, or line chart format. The default display type can be configured.

Reports can be configured to start in a past date, such as a week back so it is easy to compare last week's revenue with this week's revenue in two separate reports on a dashboard.

Reports can be configured to display in hours, days, weeks, or months. If the start to end time span is too great, some items (like hours) will be disabled as the report would be too wide and unreadable. The default display unit can be configured.

When setting up a row, there are several options to consider. A date field is set to display results at the right time. This is for date sorting purposes, so a form has a date/time field to be usable in reports. If the report should be split by a form reference, list item, or user, that option can be configured for the row. The system knows that if one row is being split by user, all rows are also split by the user, or if all rows are split by a form reference, then all rows are split with a form reference. This keeps the reports uniform.

The general ‘search criteria’ is used to filter which form entries should be used in the row. If no search criteria is added, all form entries will be counted and displayed in the row.

There are 4 options for calculations based off the form entry count after the search criteria filtering:

(1) Using a numeric multiplier multiplies the entry count by a static number.

(2) Using a numerical form value multiplier multiplies each entry by a number contained within the form entry itself. For example, for a revenue report, the ‘actual amount paid’ field would be multiplied by the number of entries for the time span to get the total revenue for each time span.

(3) Using a user form value multiplier takes a numerical field value from the user profile and multiplies it by the entry count. This user value can override the numeric multiplier, or it can be multiplied in series with the numerical multiplier.

(4) An aggregate condition can take the total entry count after filtering and manipulate the entry count based on the number of entries counted for a day, business week (which can be configured to start any day of the week), or month. For example, if the entry count for one business week is greater than 5, this option can say to remove the first 5 from that business week for the row. That total count would then be multiplied by any numeric, numerical field, or user field values. A specific use case for this option would be in a payroll report where a user gets a higher commission if he tows more than 5 vehicles in a business week.

Additionally, the base form type can be a parent form of the form entries being aggregated. That way, filtering can be done on two distinct form types. For example, an account is a parent form of a PPI form. The account items can be filtered on, and the PPI items can be filtered at the same time. Account items can be used in multipliers, and PPI items can be used as multipliers at the same time. This allows for even more configurability in that parent form data can be used in calculations and filtering.

Any of the multipliers can be multiplied together to form more complex rows, but it is usually the best idea to keep each row simple and have more rows. Each row is summed to form an aggregate total for each date range and sub date ranges.

To calculate a report row:
1 Query the MySQL database 112 with the selected date range and get a count of how many form items were within that date range.
2 In the query, filter with any base form ‘search criteria’ or aggregate form ‘search criteria.’ The aggregate form is the type of form being counted, while the base form is either the same type of form being counted, or a parent form of the form type being counted.
3 If an aggregate count condition is specified, then the condition is matched against the total count. If the condition matches, the number of items specified is added to the aggregate count for that row.
4 If no multipliers were specified for the form, nothing else is done for the row calculation.
5 If multipliers were specified, a generalized multiplier is generated based on the different types of multipliers:
   a If the numeric field is specified for a parent form or an aggregate form type, the value from the specified form is retrieved from the database 112 and put into the generalized multiplier.
   b If the user multiplier is specified, the value from the specified user's account is retrieved from the database 112 and put into the generalized multiplier.
   c If the numeric multiplier is specified, the value is put into the generalized multiplier, except when user multiplier is overriding the numeric multiplier. In that case, the numeric multiplier is skipped.
   d After the generalized multiplier is calculated, the total value is calculated by multiplying the aggregate count by the generalized multiplier for each date range.

After all the rows are calculated, each row is added together to form an aggregate for each date span in the chart. The results are displayed in the format chosen by the user: table, pie, or line chart.

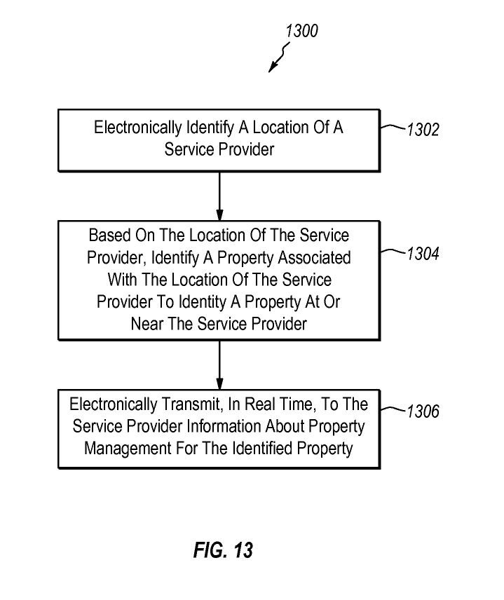

Referring now to FIG. 13, a method 1300 is illustrated. The method 1300 includes acts for providing information for a property. The information comprising property management information related to tasks to be performed on the property. The method includes electronically identifying a location of a service provider (act 1302). For example, as illustrated above, GPS, cellular tower triangulation, Wi-Fi location services, etc. can be used to identify a service provider having a device capable of gathering such information.

The method 1300 further includes, based on the location of the service provider, identifying a property associated with the location of the service provider to identity a property at or near the service provider (act 1304). For example, as illustrated in FIG. 1, the property location 102 may be identified.

The method 300 further includes electronically transmitting, in real time, to the service provider information about property management for the identified property (act 1306). In the example illustrated in FIG. 1, such information includes things such as property management rules, a list of tasks to be performed, a list of tasks that should not be performed, parking rules and/or towing criteria for the property, a list of vehicles to be towed a list of vehicles that should not be towed and/or other information. While the examples illustrated above have been illustrated in the context of a towing company, it should be appreciated that the invention may be applied to other service providers in alternative embodiments such as in the security patrol service, pest control service, repossession companies, and many other fields that require field agents to do unsupervised or supervised work.

Although the method acts described above may be discussed in a certain order or illustrated in a flow chart as occurring in a particular order, no particular ordering is required unless specifically stated, or required because an act is dependent on another act being completed prior to the act being performed.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for providing information for a property, the information comprising property management information related to tasks to be performed on the property, the method comprising:
electronically identifying a location of a service provider;
based on the location of the service provider, identifying a property associated with the location of the service provider to identity a property at or near the service provider; and
electronically transmitting, in real time, to the service provider information about property management for the identified property.

2. The method of claim 1, wherein transmitting information about property management for the identified property comprises transmitting property management rules.

3. The method of claim 1, wherein transmitting information about property management for the identified property comprises transmitting a list of tasks to be performed.

4. The method of claim 1, wherein transmitting information about property management for the identified property comprises transmitting a list of tasks that should not be performed.

5. The method of claim 1, wherein the service provider represents a towing company and wherein transmitting information about property management for the identified property comprises transmitting parking rules and/or towing criteria for the property.

6. The method of claim 1, wherein the service provider represents a towing company and wherein transmitting information about property management for the identified property comprises transmitting a list of vehicles to be towed.

7. The method of claim 1, wherein the service provider represents a towing company and wherein transmitting information about property management for the identified property comprises transmitting a list of vehicles that should not be towed.

8. The method of claim 1, wherein the acts are performed in response to user input from the service provider.

9. A system for providing information for a property, the information comprising property management information related to tasks to be performed on the property, the system comprising
one or more processors; and
one or more computer readable media coupled to the one or more processors, wherein the one or more computer readable media comprise computer executable instructions that when executed by at least one of the one or more processors cause the following to be performed:
electronically identifying a location of a service provider;
based on the location of the service provider, identifying a property associated with the location of the service provider to identity a property at or near the service provider; and
electronically transmitting, in real time, to the service provider information about property management for the identified property.

10. The system of claim 9, wherein transmitting information about property management for the identified property comprises transmitting property management rules.

11. The system of claim 9, wherein transmitting information about property management for the identified property comprises transmitting a list of tasks to be performed.

12. The system of claim 9, wherein transmitting information about property management for the identified property comprises transmitting a list of tasks that should not be performed.

13. The system of claim 9, wherein the service provider represents a towing company and wherein transmitting information about property management for the identified property comprises transmitting parking rules and/or towing criteria for the property.

14. The system of claim 9, wherein the service provider represents a towing company and wherein transmitting information about property management for the identified property comprises transmitting a list of vehicles to be towed.

15. The system of claim 9, wherein the service provider represents a towing company and wherein transmitting information about property management for the identified property comprises transmitting a list of vehicles that should not be towed.

16. The system of claim 9, wherein the acts are performed in response to user input from the service provider.

17. A physical computer readable storage medium comprising computer executable instructions that when executed by one or more processors causes the following to be performed:
electronically identifying a location of a service provider;
based on the location of the service provider, identifying a property associated with the location of the service provider to identity a property at or near the service provider; and
electronically transmitting, in real time, to the service provider information about property management for the identified property.

18. The physical computer readable storage medium of claim 17, wherein transmitting information about property management for the identified property comprises transmitting property management rules.

19. The physical computer readable storage medium of claim 17, wherein transmitting information about property management for the identified property comprises transmitting a list of tasks to be performed.

20. The physical computer readable storage medium of claim 17, wherein transmitting information about property management for the identified property comprises transmitting a list of tasks that should not be performed.
